(19) United States
(12) Patent Application Publication
(10) Pub. No.: US 2026/0091426 A1
(43) Pub. Date: Apr. 2, 2026

(54) FASTENER INSERTION APPARATUS

(71) Applicant: Atlas Copco IAS UK Limited, Flintshire (GB)

(72) Inventors: Samuel Williams, Flintshire (GB); Elliot Jones, Flintshire (GB); Jordan Syme, Flintshire (GB)

(21) Appl. No.: 19/112,010

(22) PCT Filed: Sep. 15, 2023
(86) PCT No.: PCT/GB2023/052398

§ 371 Date: Mar. 14, 2025

(30) Foreign Application Priority Data
Sep. 16, 2022 (GB) 2213608.9

(51) Int. Cl. B21J 15/36; B21J 15/02; F16B 5/04

(52) U.S. Cl. CPC B21J 15/36; B21J 15/025; F16B 5/04

(57) ABSTRACT

There is disclosed a rivet die (13) for a rivet setting tool (2). The rivet die (13) comprises a main body (20) that defines an upper surface (39). The rivet die (13) further comprises a die cavity (21) that is formed in the upper surface (39). The die cavity (21) is defined at least in part by a base surface (42). The base surface (42) comprises a groove (50) that extends at least partly around a central axis C, a first portion (46) through which the central axis C extends, and a second portion (48). The groove (50) is disposed radially outwards of the first portion (46). The second portion (48) is disposed radially outwards of the groove (50). The groove (50) and the second portion 48 border one another at an interface (56). The first portion (46) defines a first portion depth d1 in a direction along the central axis C. The interface (56) defines an interface depth d5 in a direction along the central axis C. The first portion depth dl is less than the interface depth d5.

### FIELD OF INVENTION

The present invention relates to a rivet die, a rivet setting tool incorporating such a die and associated method. The rivet die, rivet setting tool and method have particular, but not exclusive, application to forming a joint with a self-piercing rivet whereby the rivet is inserted into a workpiece including sheet material.

### BACKGROUND

Rivets can be used in a variety of applications, and are generally used to secure multiple layers (or sheets) of a workpiece to one another. In some applications, a rivet may be inserted into a workpiece that includes only a single layer (or sheet). Self-piercing rivets do not require the workpiece to include a pre-formed hole—the rivet punches a hole in the workpiece, which receives the rivet, during the rivet setting operation.

Using self-piercing rivets in a joining process reduces the number of production steps, as compared to conventional riveting in which a hole first has to be created in the workpiece, the rivet inserted in the hole, and then its projecting end (that has been inserted through the hole) upset (deformed so that it expands to interlock with the workpiece). In a self-piercing rivet setting operation no hole is initially created in the workpiece—the self-piercing rivet is driven directly into the workpiece to create its own hole which extends part way through the workpiece. A shank of the rivet is upset as it is driven into the workpiece. A self-piercing rivet setting operation usually uses a die to support the workpiece while the rivet is inserted (or driven) into the workpiece. The die may have a flat surface, or may have a cavity to accommodate and/or direct the plastic flow of the workpiece material during the rivet setting operation to assist with deformation of the rivet shank to produce the required interlock.

Low ductility material, such as cast aluminium, generally has an increased likelihood of cracks forming during a rivet setting operation. Cracks are undesirable because, for example, they can lead to ingress of fluids, which can lead to corrosion and ultimately joint failure. It is one object of the present invention to provide a rivet die, a rivet setting tool and associated methods which obviate or mitigate disadvantages with existing apparatus and methods, whether mentioned above or otherwise, and/or to provide an improved or alternative rivet die, rivet setting tool or method.

### SUMMARY

In a first aspect of the invention there is provided a rivet die for a rivet setting tool. The rivet die comprises a main body that defines an upper surface. The rivet die further comprises a die cavity that is formed in the upper surface. The die cavity is defined at least in part by a base surface. The base surface comprises a groove that extends at least partly around a central axis, a first portion through which the central axis extends, and a second portion. The groove is disposed radially outwards of the first portion. The second portion is disposed radially outwards of the groove. The groove and the second portion border one another at an interface. The first portion defines a first portion depth in a direction along the central axis. The interface defines an interface depth in a direction along the central axis. The first portion depth is less than the interface depth.

The depth of the first portion may be understood to refer to a minimum depth of the first portion. The interface depth may be understood to refer to a minimum depth of the interface.

The groove may be an annular groove.

When a die according to this aspect of the invention is used to carry out a rivet setting operation on a workpiece, the material of the workpiece deflects such that it is supported by the first portion of the base surface (and by the upper surface of the main body—in particular a portion of the upper surface which is radially outwards of the die cavity). Since the first portion depth is less than the interface depth, and since the groove is disposed radially outwards of the first portion, the workpiece is centrally supported throughout the rivet setting operation. Since the workpiece is centrally supported throughout the rivet setting operation, the workpiece is subjected to compressive stress throughout the rivet setting operation. The workpiece being subjected to compressive stress throughout the rivet setting operation advantageously reduces the likelihood of cracking of the workpiece occurring during a rivet setting operation.

As the rivet setting operation continues, the material of the workpiece deforms into the groove, which compresses the material that is received within the groove. Compressing the material that is received within the groove further reduces the likelihood of cracking of the workpiece occurring during a rivet setting operation. Furthermore, any cracks that may form are at least partially closed by this compression.

The second portion may define a second portion depth that extends in a direction along the central axis. The entirety of the depth of the first portion may be less than the entirety of the depth of the second portion.

Where the depth of entirety of the first portion is less than the depth of the entirety of the second portion, the magnitude of the compression that the workpiece is subject to during a riveting operation may be increased relative to a situation in which the depth of a portion of the second portion is less than the depth of a portion of the first portion. Increasing the magnitude of the compression further reduces the likelihood of cracks forming during a rivet setting operation.

The first portion may be planar. The entirety of the first portion may be planar.

The first portion being planar may be understood to mean that all points of the first portion lay in a common plane.

The plane of the first portion may be generally perpendicular to the central axis.

Where the first portion is planar, the stress distribution of the workpiece during a rivet setting operation is advantageously more even as compared to where the first portion is non-planar. A more even stress distribution advantageously further reduces the likelihood of cracks forming during a rivet setting operation.

The first portion may define a diameter with respect to the central axis. The second portion may define a radial width.

A ratio of the diameter of the first portion to the radial width of the second portion may be less than four.

Put another way, the radial width of the second portion multiplied by a factor of two may be greater than a radius of the first portion.

The ratio of the diameter of the first portion to the radial width of the second portion may be calculated by dividing the diameter of the first portion by the radial width of the second portion.

Where the ratio of the diameter of the first portion to the radial width of the second portion is less than four, or in any other embodiment disclosed in this document, the interface between the groove and the second portion may be disposed at a point of inflection defined by the base surface. The point of inflection may be disposed at a location that, when moving radially outwards along the base surface from a radial midpoint of the groove, the base surface changes from being concave to being convex.

Where the ratio of the diameter of the first portion to the radial width of the second portion is less than four, or in any other embodiment disclosed in this document, an interface between the groove and the first portion may be disposed at a point of inflection defined by the base surface. The point of inflection may be disposed at a location that, when moving radially inwards along the base surface from a radial midpoint of the groove, the base surface changes from being concave to being convex.

Where the ratio of the diameter of the first portion to the radial width of the second portion is less than four, or in any other embodiment disclosed in this document, a radially outer extremity of the second portion may be disposed at a point of inflection defined by the base surface. The radially outer extremity of the second portion may interface a side wall of the base surface. The point of inflection may be disposed at a location that, when moving radially outwards along the second portion of the base surface, the base surface changes from being concave to being convex.

The diameter of the first portion may extend to the interface between the first portion and the groove. The radial width of the second portion may extend, in a direction perpendicular to the central axis, from the interface between the groove and the second portion of the base surface to the radially outer extremity of the second portion as defined above.

Where the ratio of the diameter of the first portion to the radial width of the second portion is less than four, the material of the workpiece is better supported during insertion of a rivet. This is because the likelihood of the workpiece flowing into the groove while not being in contact with the second portion is reduced. The workpiece flowing into the groove without being in contact with the second portion increases the likelihood that the workpiece will crack during rivet insertion. Therefore, the above ratio advantageously reduces the likelihood of the workpiece cracking during a rivet insertion operation using the die.

The diameter of the first portion may be greater than or equal to the radial width of the second portion.

The groove may define a groove radial width. The groove radial width may be at least 5% of the diameter of the first portion.

The radial width of the groove may be up to 300% (i.e., up to four times greater than) of the diameter of the first portion.

The die cavity may define a die cavity depth in a direction along the central axis. The groove may define a groove depth in a direction along the central axis.

The die cavity depth may be understood to refer to a maximum depth of the die cavity. The die cavity depth may extend from the upper surface of the main body (in particular, from a portion of the upper surface radially outwards of the die cavity) to a base surface of the groove (which is a portion of the base surface that defines a base of the groove). The groove depth may extend from the interface to the base surface of the groove.

The groove depth may be less than or equal to 75% of the die cavity depth.

The groove depth may be less than or equal to 40% of the die cavity depth.

Where the groove depth defines less than or equal to 75% of the die cavity depth, the compression that the material of the workpiece that enters the groove during a rivet setting operation is increased relative to where the groove depth defines more than 75% of the die cavity depth. Increasing the compression that the material of the workpiece that enters the groove is subject to further reduces the likelihood of cracks forming during the rivet setting operation. In addition, the closure force applied to any cracks that do form during the rivet setting operation is increased relative to where the groove depth defines more than 75% of the die cavity depth.

The interface depth may be at least 3% greater than the first portion depth.

The interface depth may be at least 5% greater than the first portion depth. The interface depth may be up to 0.05 mm greater than the first portion depth. The interface depth may be up to 0.1 mm greater than the first portion depth.

The interface depth may be up to 300% greater than the first portion depth. The interface depth may be up to 200% greater than the first portion depth.

Where the interface depth is at least 3% greater than the first portion depth, the likelihood of the workpiece being subject to a tensile force is reduced as compared to where the interface depth is less than 3% greater than the first portion depth. This advantageously further reduces the likelihood of cracks forming in the workpiece during a rivet setting operation.

At least part of the first portion may be perpendicular to the central axis. At least part of the second portion may be perpendicular to the central axis.

The entire first portion may be perpendicular to the central axis. The entire second portion may be perpendicular to the central axis.

The rivet die may further comprise a stem. The stem may extend from a lower surface of the main body. The lower surface may be opposed to the upper surface.

The upper surface may define an outer rim. The outer rim may be disposed radially outwards of the die cavity.

The outer rim may be disposed radially outwards of the base surface.

The groove may define a radial midpoint. The radial midpoint may define a radial midpoint diameter. The groove may be configured such that the radial midpoint diameter is greater than or equal to a bore internal diameter of a rivet provided to the rivet setting tool prior to insertion of the rivet.

The radial midpoint of the groove may be understood to refer a midpoint in the radial direction between a radially innermost edge and a radially outermost edge of the groove. The radial midpoint of the groove may be a locus of points located at a midpoint radius relative to the central axis.

Following the rivet setting operation on a workpiece which comprises a plurality of sheets of material to be joined, a bottom sheet of the workpiece (the sheet which is located furthest from an upper surface of the workpiece which is the surface of the workpiece to be contacted first by the rivet during a rivet setting operation) defines a minimum thickness (which may be the shortest distance between a portion of an upper surface of the bottom sheet and a portion of a bottom surface of the bottom sheet). If the minimum thickness is too small, the joint produced by virtue of the rivet setting operation is prone to failure. For example, the joint may be prone to moisture ingress, which can lead to corrosion. The minimum thickness for any rivet setting operation is generally disposed in the region of the tip of the rivet. Where the radial midpoint diameter is greater than or equal to the bore internal diameter of the rivet provided to the rivet setting tool, the minimum thickness of the workpiece is greater than if the radial midpoint diameter is less than the bore internal diameter of the rivet. This advantageously reduces the likelihood of the joint produced by virtue of the rivet setting operation being defective.

The first portion of the base surface may be continuous.

The first portion of the base surface being continuous may be understood to mean that the first portion does not include any holes, recesses. In some embodiments, the first portion of the base surface being continuous may be understood to mean that the first portion does not include any discontinuities or irregularities.

In a second aspect of the invention there is provided a rivet setting tool. The rivet setting tool is configured to insert a rivet into a workpiece. The rivet setting tool comprises a die according to the first aspect of the invention located beneath a punch that is reciprocally movable by an actuator.

The advantages discussed in relation to the first aspect of the invention apply to this aspect mutatis mutandis.

According to a third aspect of the invention there is provided a method of forming a joint. The method of forming the joint comprises providing a rivet setting tool according to the second aspect of the invention. The method further comprises providing the rivet setting tool with a rivet. The method further comprises providing a workpiece. The method further comprises positioning the workpiece between the die and the punch. The method further comprises urging the rivet into the workpiece by advancing the punch using the actuator.

The workpiece may comprise two or more sheets (which may also be referred to as layers).

The rivet may be a self-piercing rivet.

The groove may define a radial midpoint. The radial midpoint may define a radial midpoint diameter. The rivet may define a shank external diameter. The radial midpoint diameter may be greater than or equal to the bore internal diameter.

The shank external diameter may refer to the diameter of the outer periphery of the shank prior to urging the rivet into the workpiece. The shank external diameter may be the maximum diameter (relative to a central axis of the rivet), prior to urging the rivet into the workpiece, of a tip of the shank of the rivet. The tip may be a portion of the rivet which is located the greatest axial distance from a head of the rivet.

The advantages discussed in relation to the first aspect of the invention apply to this aspect mutatis mutandis.

At least one of the workpiece layers (or sheets) may be made from a material having a ductility that is less than or equal to 12%.

All of the workpiece layers may be made from a material or materials having a ductility of less than or equal to 12%. At least one or all of the workpiece layers may be made from a material or materials having a ductility of less than or equal to 8%.

The material may be a cast material. The material may be cast aluminium.

The workpiece may comprise an upper sheet that defines an upper surface of the workpiece. The workpiece may comprise a lower sheet that defines a lower surface of the workpiece.

After being urged into the workpiece, the rivet may not extend through the lower surface of the workpiece.

The lower sheet may be formed from a material that is less ductile than the upper sheet.

The lower sheet may be formed from a cast material. The lower sheet may have a ductility of less than 12% elongation at break. The lower sheet may have a ductility of less than 10% elongation at break. The lower sheet may be at least 2 mm thick. The lower sheet may be up to 5 mm thick.

The rivet may have a hardness of at least 380 hv10 and/or up to 580 hv10.

According to a fourth aspect of the invention there is provided a product or component of a product manufactured using a method according to the third aspect of the invention.

The product may be a vehicle.

According to a fifth aspect of the invention there is disclosed a method of forming a self-piercing riveted joint between separate portions of a workpiece. The method comprises providing i) a die that defines a central axis and a die cavity that defines a base surface, ii) said workpiece, iii) a punch, and iv) a self-piercing rivet. The method further comprises positioning the workpiece between the die and the punch. The method further comprises urging the rivet into the workpiece using the punch such that i) at least part of the workpiece flows to come into contact with the base surface of the die; ii) at least part of the workpiece flows radially outwardly; iii) at least part of the workpiece flows downwardly to enter a groove of a base surface of the die; iv) at least part of the workpiece substantially fills the groove; and v) at least part of the workpiece flows radially outwardly beyond the groove. While the rivet is being urged into the workpiece, the rivet flares such that the rivet interlocks with at least part of the workpiece thereby creating the joint between the separate portions of the workpiece.

Throughout this document, the term ‘flow’ when used with reference to the workpiece may be understood to refer to deformation of the relevant part of the workpiece.

To substantially fill the groove, at least part of the workpiece may flow upwardly and at least part of the workpiece may flow downwardly.

Downward or upward flow of the workpiece may be understood to mean the direction of the flow has a component in a vertical direction. That is to say, the flow is not purely horizontal.

At least part of the workpiece that flows upwardly may also flow radially outwardly. At least part of the workpiece that flows downwardly may also flow radially outwardly.

Where at least part of the flows upwardly and at least part of the workpiece flows downwardly to substantially fill the groove, the workpiece material is compressed by the different portions of the workpiece flowing in different directions. This reduces the likelihood of cracks forming in the workpiece while forming the joint, and also helps to close any cracks that may form while forming the joint.

To substantially fill the groove, at least part of the workpiece may flow downwardly. To substantially fill the groove, at least part of the workpiece may flow upwardly.

(i) to (v) may begin sequentially.

One or more of (i) to (v) may occur simultaneously with another one or more of i) to v).

Sequentially means in the order specified (i.e. (i), (ii), (iii), (iv) then (v).

Radially outward flow of the workpiece may bring the workpiece into contact with a sidewall of the die.

The groove may be disposed radially outwards of a first portion of the base surface. A second portion of the base surface may be disposed radially outwards of the groove. The groove and the second portion may border one another at an interface.

The first portion defines a first portion depth in a direction along the central axis, and wherein the interface defines an interface depth in a direction along the central axis, the first portion depth being less than the interface depth.

The workpiece may flow radially outwardly in step (ii) along the first portion of the base surface.

The workpiece may flow radially outwardly in step (v) along the second portion of the base surface.

### BRIEF DESCRIPTION OF THE DRAWINGS

Embodiments of the present invention will now be described with reference to the accompanying drawings, in which:

FIG. 1 shows a rivet insertion apparatus according to an embodiment of the present invention that includes a rivet die according to an embodiment of the present invention;

FIG. 2 shows a cross-sectional side view of the rivet insertion apparatus of FIG. 1;

FIG. 3 shows a cross-sectional side view of the rivet die of FIG. 1;

FIG. 4 shows an enlarged view of section ‘A’ of FIG. 3; and

FIGS. 5 to 10 show computed simulator cross-sectional side views of a rivet insertion apparatus according to an embodiment of the present invention at first, second, third, fourth, fifth and sixth stages respectively of a fastener insertion process.

### DETAILED DESCRIPTION

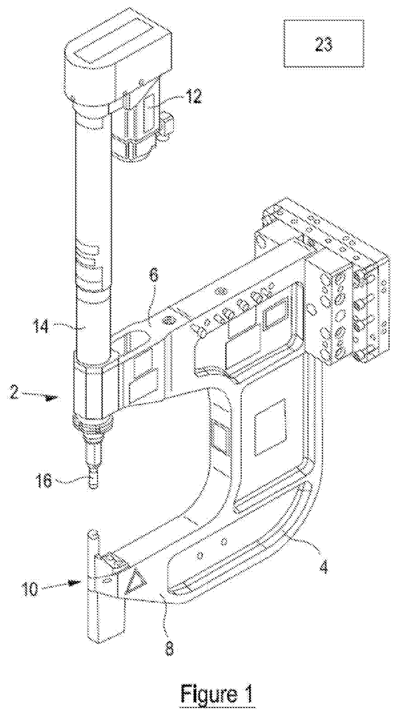

FIG. 1 shows a rivet insertion apparatus (rivet setting tool) 2 and an associated carrier. The carrier comprises a C-frame 4, which has an upper jaw 6 and a lower jaw 8. A die assembly 10 is provided on the lower jaw 8 of the C-frame 4. The rivet insertion apparatus 2 inserts rivets into a workpiece (not depicted) which is located over the die assembly 10, as described further below.

The rivet insertion apparatus 2 comprises an electric drive 12 that operates to drive an inertially driven reciprocal punch (not visible in FIG. 1) which moves axially in a cylindrical housing 14 and a nose assembly 16. Although an inertial electric drive is depicted, other forms of drive may be used. For example, the electric drive may comprise an electric motor, which directly drives the punch (and which may be controlled based upon real-time feedback regarding the position of the punch). In another example, a hydraulic drive may be used. However, an electric drive may be preferred because it does not require delivery of hydraulic fluid (delivering hydraulic fluid may be difficult, and the hydraulic fluid may pose a health and safety risk if it leaks). The reciprocal punch is used to insert rivets from the nose assembly 16 through a workpiece (not depicted). The reciprocal punch may contact a head portion of a rivet and impart a force to the rivet which drives the rivet into the workpiece. The rivet insertion apparatus 2 may further comprise an additional drive (not visible) which may be used to clamp the nose assembly 16 onto the workpiece during insertion of a rivet and during upsetting of the rivet (as described further below). The electric drive 12 and the additional drive may be independently controllable (e.g. using a control apparatus). The additional drive may for example be an electric drive or a hydraulic drive. An example of a drive that may be used to clamp the nose assembly 16 onto the workpiece is described in U.S. Pat. No. 5,752,305.

Rivets are supplied under air (or other gas) pressure via a delivery tube (not shown) to the nose assembly 16. The rivets are then inserted into the workpiece. In an alternative arrangement, the rivets may be supplied by transportation to the nose assembly 16 in a carrier tape.

A control system 23 is configured to control delivery of rivets to the nose assembly 16, and is configured to control operation of the reciprocal punch. The control system 23 may also control other parts of the rivet insertion apparatus 2, such as the drive that moves the punch and the drive that moves the nose. The control system 23 may comprise a processor and a memory, the memory storing instructions regarding operation of the rivet insertion apparatus 2. The processor may process the instructions and provide outputs that control operation of the rivet insertion apparatus 2.

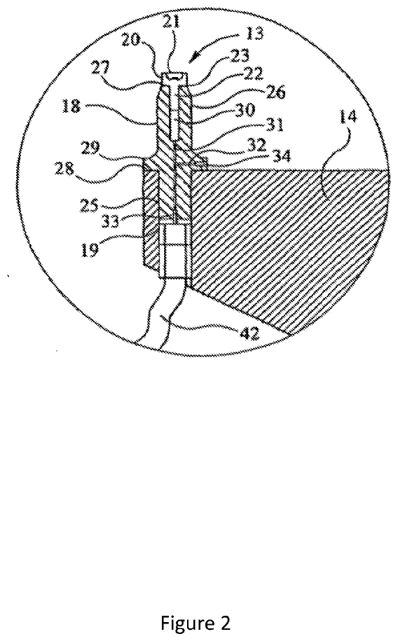

The die assembly 10 is shown in more detail in FIG. 2. The die assembly 10 includes a die 13 that is supported on the lower jaw 8 of the C-frame 4 by a die holder adapter 18 that is received in a bore 19 that extends through the jaw 8. Since the die 13 is for a rivet insertion apparatus, the die may be referred to as a rivet die. In some embodiments, the die holder adapter 18 is not provided. In embodiments in which the die holder adapter is not provided, the die 13 is secured directly to the C-frame 4. The die 13 is generally cylindrical about a central axis (not depicted in FIG. 2). The die 13 comprises a head (or main body) 20 from which a stem 22 depends, extending along the central axis. The depending stem 22 is of reduced diameter compared to the head 20. An underside surface 23 extends radially relative to the central axis is defined on the underside of the head 20. The underside surface 23 is annular. The adapter 18 has a generally cylindrical body with a first end 25 that is received in a snug fit in the bore 19 in the jaw 8 of the C-frame 4 and a second hollow end 26 that receives the die stem 22 such that the annular underside surface 23 of the die is seated on an upper surface 27 of the second end 26. A sealing member such as, for example, an O-ring or the like may be provided between the adapter 18 and an upper surface 28 of the surface of the jaw 8 in which the bore 19 is defined. The adapter body has a radially outward extending flange 29 defined part way along its outer surface with one of the radially extending faces being seated on the upper surface 28 of the jaw 8 immediately around the bore 19. The second hollow end 26 is tapered inwardly, and terminates in the annular upper surface 27 on which the underside surface 23 of the head 20 is supported. The second end 26 being tapered allows the die 13 to sit flush on the upper surface 27 of the second end 26. A cylindrical bore 30 extends within the adapter body from the second end 26 to a position substantially half way along its length and receives the die stem 22 by a slip fit or friction fit.

It is to be appreciated that, in other embodiments, the bore 19 in the lower jaw 8 of the C-frame can have a reduced diameter such that the die holder adapter 18 can be eliminated, in which case the lower jaw 8 of the C-frame in the region around the bore 19 serves to hold the die via its stem directly.

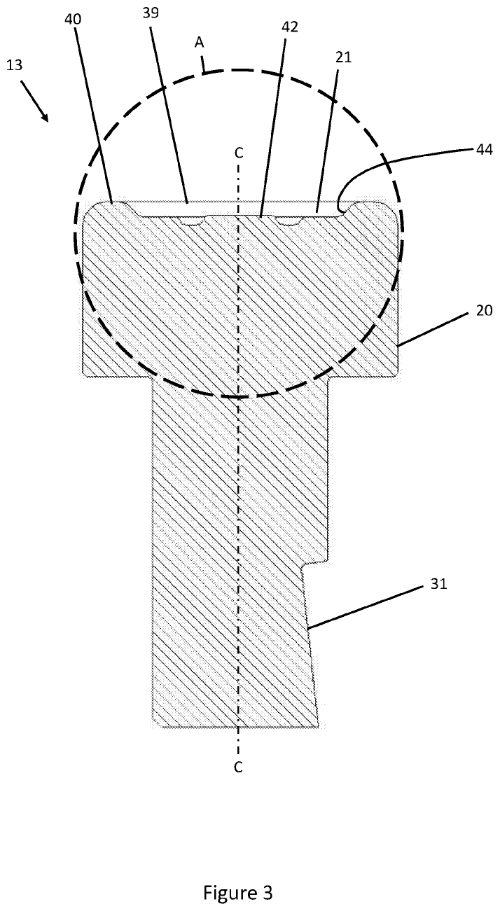

FIG. 3 shows a cross-sectional side view of the die 13. The head 20 of the die comprises an upper die surface 39. The die surface 39 comprises an outer rim 40. The die surface 39 comprises a base surface 42. The outer rim 40 is disposed radially outwards of the base surface 42. The die surface 39 comprises a sidewall 44. The sidewall 44 extends between the outer rim 40 and the base surface 42. The outer rim 40 includes a generally planar (radially extending) portion. During a rivet setting operation, the outer rim 40 supports the workpiece (not shown in FIG. 3) into which a rivet (not shown in FIG. 3) is to be inserted, as will be discussed in more detail below. A die cavity 21 is formed in the upper die surface (or upper surface) 39. The die cavity 21 defines a die cavity volume. The die cavity volume may be greater than the volume of a rivet to be inserted into a workpiece using a fastener insertion apparatus having the die 13. This reduces the likelihood of cracks forming in the workpiece as a result of a fastener insertion operation.

The stem 22 of the die 13 comprises a flat land 31. To secure the die 13 to the adapter 18, a fastener, such as a grub screw, extends through an aperture that extends through the adapter and engages the flat land 31. Where the adapter is not provided, the fastener extends through an aperture that extends through the C-frame and engages the flat land 31.

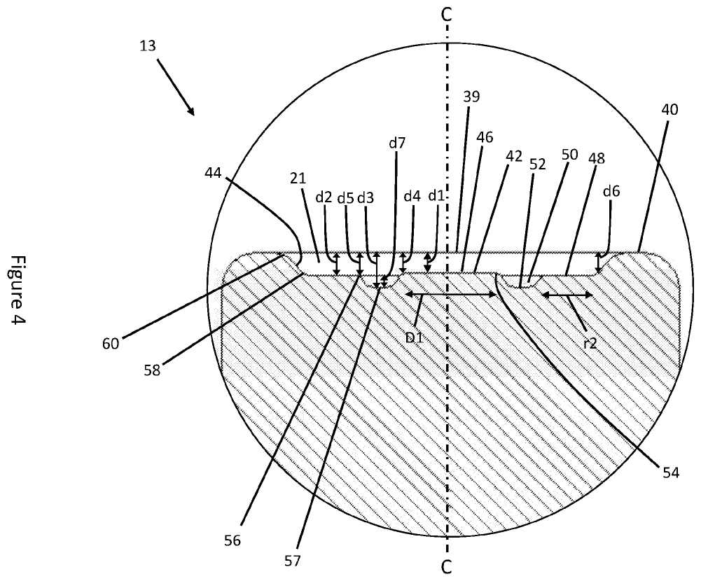

FIG. 4 shows an enlarged view of region ‘A’ of FIG. 3. The die cavity 21 is defined in part by the base surface 42. The base surface 42 may also be referred to as a base portion (of the die surface 39). The die cavity 21 is defined in part by the sidewall 44. The sidewall 44 extends circumferentially around the base surface 42. The sidewall 44 may therefore be referred to as a circumferential sidewall. The sidewall 44 is shaped such that the die cavity 21 is generally frustoconical. However, in other, non-depicted embodiments, the sidewall 44 may extend parallel to the central axis C such that the die cavity is generally cylindrical. The base surface 42 comprises a first portion 46, a second portion 48 and a groove 50. The groove 50 is disposed radially outwards of the first portion 46. The second portion 48 is disposed radially outwards of the groove 50. Hence, the groove 50 is disposed radially between the first portion 46 and the second portion 48.

The central axis C of the die 13 extends through the first portion 46. The first portion 46 is generally perpendicular to the central axis C. In some embodiments, some or all of the first portion may be non-perpendicular to the central axis C. The first portion 46 is generally planar. In some embodiments, the first portion 46 may be dome-shaped. Where the first portion 46 is dome-shaped, the first portion 46 may be convex or concave. The first portion 46 is continuous. The first portion 46 being continuous may be understood to mean that the first portion 46 does not include any holes, recesses, or other discontinuities. In some embodiments, the first portion 46 may not be continuous. The first portion 46 defines a diameter D1 that extends between diametrically opposed points, the points each being disposed where the first portion 46 adjoins (or interfaces) the groove 50. The first portion 46 defines a first portion depth d1. The first portion depth d1 extends in a direction along the central axis C. The first portion depth d1 extends from the outer rim 40 of the die 13 to the first portion 46 of the base surface 42. The depth d1 may extend from the portion of the outer rim 40 which may be said to be the upper-most portion of the outer rim—this is the portion of the outer rim which is located furthest along the central axis C from the stem 22.

The second portion 48 is generally planar (that is to say, it includes a planar portion, or it may be entirely planar). The second portion 48 is continuous. The second portion 48 being continuous may be understood to mean that the second portion 48 does not include any holes, recesses, or other discontinuities. In some embodiments, the second portion 48 may not be continuous. The second portion 48 is generally annular. The second portion 48 defines a radial width r2. The radial width r2 of the second portion 48 is the radial distance between i) where second portion 48 adjoins the sidewall 44; and ii) where the second portion 48 adjoins the groove 50. The diameter D1 of the first portion 46 is greater than or equal to the radial width r2 of the second portion 48. However, in other embodiments, the diameter D1 of the first portion 46 may be less than the radial width r2 of the second portion 48. The size of the radius of the first portion 46 and of the radial width of the second portion 48 relative to one another may be determined based on, for example, the material from which the workpiece to be joined in a rivet setting operation using the die 13 is made. The second portion 48 is generally perpendicular to the central axis C. The second portion 48 is generally parallel to the first portion 46. In some embodiments, at least part of the second portion 48 may be angled (i.e. non-parallel) with respect to the first portion 46. In some embodiments, at least part of the second portion 48 may be curvilinear. The second portion 48 defines a second portion depth d2. The second portion depth d2 extends in a direction along the central axis C. The second portion depth d2 extends from the outer rim 40 of the die 13 to the second portion 48 of the base surface 42. The depth d2 may extend from the portion of the outer rim 40 which may be said to be the upper-most portion of the outer rim—this is the portion of the outer rim which is located furthest along the central axis C from the stem 22. The second portion depth d2 is greater than the first portion depth d1. In the depicted embodiment, the depth d2 of the entirety of the second portion 48 is greater than the depth d1 of the entirety of the first portion 46. In some embodiments, the depth of at least part of the second portion 48 may be less than the depth of the first portion 46.

The groove 50 extends around (or encircles) the central axis C. The groove 50 extends around the central axis C in a circumferential direction. The groove 50 is generally annular. In some embodiments, the groove 50 may be arc-shaped, and so may extend only partly around the central axis C. In some embodiments, the groove 50 may be formed of a plurality of sections that may be arc-shaped. In radial cross-section, the groove 50 is generally U-shaped or parabolic. In other embodiments, the groove 50 need not be U-shaped in cross-section, but may be any other suitable shape. For example, in cross-section, the groove 50 may be V-shaped or hyperbolic. The groove 50 is defined by a groove base surface 52.

The die cavity 21 defines a die cavity depth d3. The depth d3 may be referred to as a cavity groove depth. The die cavity depth d3 extends in a direction along the central axis C. The die cavity depth d3 extends from the outer rim 40 of the die 13 to the portion of the base surface 52 of the groove 50 which has the maximum depth (i.e. the portion of the base surface which is furthest along the central axis C towards the stem 22 of the die). The depth d3 may extend from the portion of the outer rim 40 which may be said to be the upper-most portion of the outer rim—this is the portion of the outer rim which is located furthest along the central axis C from the stem 22.

The groove 50 and the first portion 46 of the base surface 42 of the die cavity 21 border or adjoin one another at a first interface 54. The first interface 54 is disposed at the radially innermost location at which, when moving from the first portion 46 in a radially outward direction, an angle between the central axis C and a normal extending from the base surface 42 is greater than 15 degrees. In some embodiments, the first interface 54 may be disposed at the radially innermost location at which, when moving from the first portion 46 in a radially outward direction, an angle between the central axis C and a normal extending from the base surface is greater than 45 degrees. The angle between the central axis C and the normal extending from the base surface that defines the position of the first interface 54 may be determined by the geometry of the first portion 46. Here and throughout this document, the angle between the central axis C and the normal extending from the base surface 42 refers to the acute angle, and not obtuse angle, between the central axis C and the normal extending from the base surface 42. In some embodiments, the first interface 54 may be disposed elsewhere. For example, in some embodiments, the first interface 54 may be disposed at a point of inflection defined by the base surface 42. The point of inflection may be disposed at a location that, when moving radially inwards along the base surface 42 from a radial midpoint 57 of the groove 50, the base surface 42 changes from being concave to being convex.

The first interface 54 defines a first interface depth d4. The first interface depth d4 extends in a direction along the central axis C. The first interface depth d4 extends from the outer rim 40 of the die 13 to the first interface 54. The first interface depth d4 may extend from the portion of the outer rim 40 which may be said to be the upper-most portion of the outer rim—this is the portion of the outer rim which is located furthest along the central axis C from the stem 22.

The first interface depth d4 is less than the second portion depth d2. In some embodiments, the depth of at least part of the second portion d2 may be less than the first interface depth d4. The base surface 42 of the die 13 is radiused in the region of the first interface 54. In other, non-depicted, embodiments, the base surface 42 may comprise any suitable geometry in the region of the first interface 54. For example, the base surface 42 may be chamfered in the region of the first interface 54, or a vertex may separate the groove 50 and the first portion 46.

The groove 50 and the second portion 48 of the base surface 42 of the die cavity 21 border one another at a second interface 56. The second interface 56 is disposed at the radially innermost location at which, when moving from the second portion 48 in a radially inward direction, an angle between the central axis C and a normal extending from the base surface 42 is greater than 15 degrees. In some embodiments, the second interface 56 may be disposed at the radially innermost location at which, when moving from the second portion 48 in a radially inward direction, an angle between the central axis C and a normal extending from the base surface is greater than 45 degrees. The angle between the central axis C and the normal extending from the base surface that defines the position of the second interface 56 may be determined by the geometry of the second portion 48. In some embodiments, the second interface 56 may be disposed elsewhere. For example, in some embodiments, the second interface 56 may be disposed at a point of inflection defined by the base surface 42. The point of inflection that defines the location of the second interface 56 may be disposed at a location that, when moving radially outwards along the base surface 42 from the radial midpoint 57 of the groove 50, the base surface 42 changes from being concave to being convex.

The second interface 56 defines a second interface depth d5. The second interface depth d5 extends in a direction along the central axis C. The second interface depth d5 extends from the outer rim 40 of the die 13 to the second interface 56. The second interface depth d5 may extend from the portion of the outer rim 40 which may be said to be the upper-most portion of the outer rim—this is the portion of the outer rim which is located furthest along the central axis C from the stem 22.

The first portion depth d1 is less than the second interface depth d5. In some embodiments, the depth of at least part of the first portion 46 is less than the second interface depth d5. In some embodiments, the entirety of the depth of the first portion 46 is less than the second interface depth d5. As will be discussed in more detail below, this, in combination with the groove 50 being disposed radially outwards of the first portion 46, results in a workpiece into which a rivet is being inserted being centrally supported throughout the majority of a rivet setting operation that uses the die 13. The base surface 42 of the die 13 is radiused in the region of the second interface 56. In other, non-depicted, embodiments, the base surface 42 may comprise any suitable geometry in the region of the second interface 56. For example, the base surface 42 may be chamfered in the region of the second interface 56, or a vertex may separate the groove 50 and the second portion 48. In the depicted embodiment, the second interface depth d5 is at least 3% greater than the first portion depth d1. The second interface depth d5 may be up to 300% greater than the first portion depth d1. This reduces the likelihood of cracks forming in a workpiece being joined in a rivet setting operation using the die 13. The difference between the first portion depth d1 and the second interface depth d5 may be selected based on, for example, the material from which the workpiece to be joined in a rivet setting operation using the die 13 is made. The first portion depth d1 is less than the second interface depth d5 regardless of the position of the second interface 56.

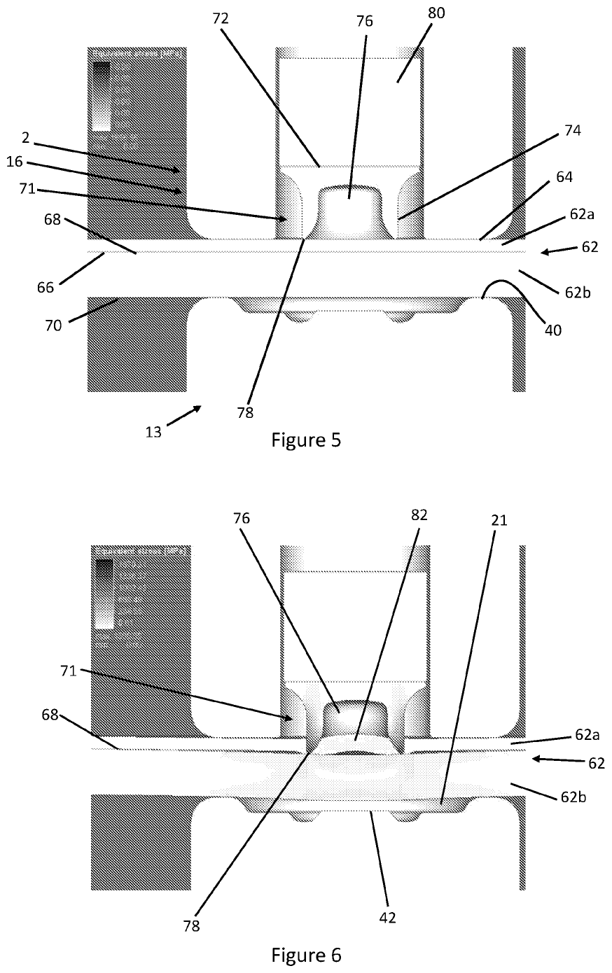

The radial midpoint 57 of the groove 50 is equidistant from the first interface 54 and the second interface 56. The radial midpoint 57 defines a radial midpoint diameter. The radial midpoint of the groove may be a locus of points located at a midpoint radius (which is half the midpoint diameter) relative to the central axis. In the present embodiment the radial midpoint 57 is generally located at the portion of the groove 50 that has the maximum depth (i.e. the portion of the base surface which is furthest along the central axis C towards the stem 22 of the die). In other geometries of the die 13, this need not be the case. The radial midpoint 57 is configured such that it (i.e., the radial midpoint diameter) is greater than or equal to a bore internal diameter of a rivet provided to the rivet insertion apparatus (not depicted in FIG. 4). The bore internal diameter may refer to the diameter (relative to the central axis) of the inner periphery of the shank prior to urging the rivet into the workpiece. The bore internal diameter may be the diameter (relative to a central axis of the rivet), prior to urging the rivet into the workpiece, of a cylindrical section of the bore of the rivet. Where the bore does not include a cylindrical section, the bore internal diameter may be the diameter of a vertex or tangent point between a leading inner bore portion and an adjacent portion of the bore. The leading inner bore geometry is the portion of the bore that adjoins the tip of the rivet. The tip may be a portion of the rivet which is located the greatest axial distance from a head of the rivet. The tip of the rivet is shown in more detail in FIGS. 5 to 10.

The radial midpoint diameter being greater than or equal to a shank internal diameter of a rivet provided to the rivet insertion apparatus reduces the likelihood of the rivet fully penetrating the workpiece into which it has been inserted in a rivet setting operation using the die 13. The rivet fully penetrating the workpiece is undesirable because this can lead to, for example, ingress of fluid, which can lead to corrosion. Full penetration of the workpiece may be considered to be when the rivet passes through all of the one or more sheets of the workpiece, such that the tip of the rivet is exposed through an underside of the workpiece, which is opposed to an upper surface of the workpiece, into which the rivet is initially driven.

The groove 50 defines a radial width. The radial width of the groove 50 is defined by the radial distance between the first interface 54 and the second interface 56. The radial width of the groove 50 is at least 5% of the diameter D1 of the first portion 46 of the base surface 42 of the die cavity 21. The radial width of the groove 50 is at least 20% of the diameter D1 of the first portion 46 of the base surface 42 of the die cavity 21. The radial width of the groove 50 may be up to 300% of the diameter D1 of the first portion 46. The radial width of the groove 50 may be up to 250% of the diameter D1 of the first portion 46. The radial width of the groove 50 being in this range advantageously optimises compression of the workpiece 62 in the groove, which reduces the likelihood of cracks forming in the workpiece during a rivet insertion operation, and closes and cracks that may have formed.

The second portion 48 of the base surface 42 of the die cavity 21 and the sidewall 44 of the die cavity border one another at a third interface 58. The third interface 58 is disposed at the radially outermost location at which, when moving from the second portion 48 in a radially outward direction, an angle between the central axis C and a normal extending from the base surface 42 is greater than 15 degrees. In some embodiments, the third interface 58 may be disposed at the radially outermost location at which, when moving from the second portion 48 in a radially outward direction, an angle between the central axis C and a normal extending from the base surface is greater than 45 degrees. The angle between the central axis C and the normal extending from the base surface that defines the position of the third interface 58 may be determined by, for example, the geometry of the second portion 48 and/or of the sidewall 44. The radial width of the second portion 48 is the radial distance between the second interface 56 to the third interface 58. In some embodiments, the radial width of the second portion may be the radial distance from the second interface 56 to a radially outer extremity of the second portion 48. The radially outer extremity of the second portion 48 may be disposed at a point of inflection defined by the base surface 42. The point of inflection may be disposed at a location that, when moving radially outwards along the base surface 42 from the second portion 48, the base surface changes from being concave to being convex. The sidewall 44 interfaces the second portion 48 at the radially outer extremity of the second portion 48. In some embodiments, the radially outer extremity of the second portion 48 may be coincident with the third interface 58.

The third interface 58 defines a third interface depth d6. The third interface depth d6 extends in a direction along the central axis C. The third interface depth d6 extends from the outer rim 40 of the die 13 to the third interface 58. The depth d6 may extend from the portion of the outer rim 40 which may be said to be the upper-most portion of the outer rim—this is the portion of the outer rim which is located furthest along the central axis C from the stem 22.

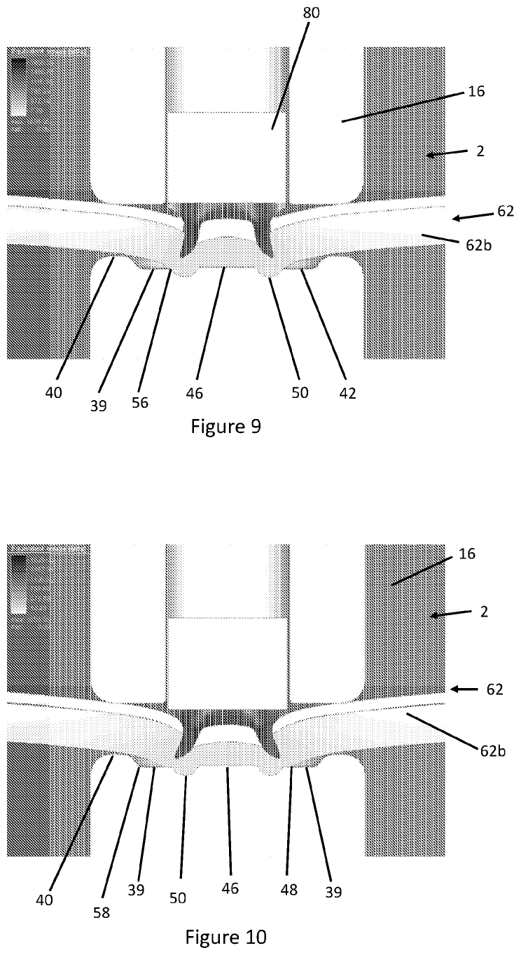

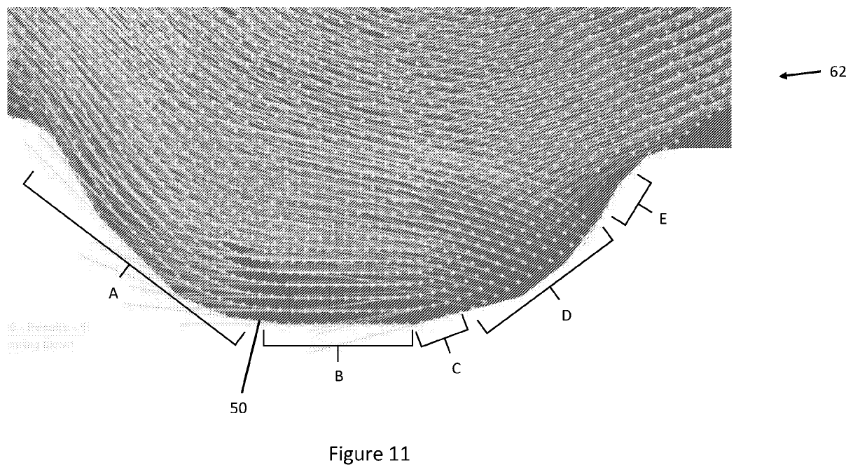

The third interface depth d6 is greater than the first portion depth d1. However, in some embodiments, the third interface depth d6 may be less than the depth of at least part of the first portion 46. The base surface 42 of the die 13 is radiused in the region of the third interface 58. In other, non-depicted, embodiments, the base surface 42 may comprise any suitable geometry in the region of the third interface 58. For example, the base surface 42 may be chamfered in the region of the third interface 58, or a vertex may separate the second portion 48 and the sidewall 44. During a rivet setting operation, the workpiece does not come into contact with third interface 58 (see, for example, FIG. 10). This is because, during the later stages of the rivet setting operation (see, for example, FIGS. 9 and 10) the workpiece is support both by the outer rim 40 and the second interface 56. However, in some embodiments, the workpiece may come into contact with the third interface 58. Whether the workpiece comes into contact with the third interface depends upon, for example, the material(s) from which the workpiece is made, the total thickness of the workpiece 62, and the geometry of the base surface 42 in the region of the third interface 58. The third interface depth d6 is greater than the first portion depth d1 regardless of the position of the third interface 58.

The sidewall 44 of the die cavity 21 and the upper surface 40 of the die 13 border one another at a fourth interface 60. The fourth interface 60 is disposed at the radially innermost location at which, when moving from the upper surface 40 in a radially inward direction, an angle between the central axis C and a normal extending from the die surface 39 is greater than 15 degrees. In some embodiments, the fourth interface 60 may be disposed at the radially innermost location at which, when moving from the upper surface 40 in a radially inward direction, an angle between the central axis C and a normal extending from the base surface is greater than 45 degrees. The angle between the central axis C and the normal extending from the base surface that defines the position of the fourth interface 60 may be determined by the geometry of the upper surface 40 and/or of the sidewall 44. The die surface 39 is radiused in the region of the fourth interface 60. In other, non-depicted, embodiments, the die surface 39 may comprise any suitable geometry in the region of the fourth interface 60. For example, the die surface 39 may be chamfered in the region of the fourth interface 60, or a vertex may separate the sidewall 44 and the upper surface 40.

It should be noted that for all of the previously mentioned distances (d1 to d6), the distances are measured (along the central axis) from the same portion of the outer rim 40. This portion of the outer rim may be said to be the upper-most portion of the outer rim—this is the portion of the outer rim which is located furthest along the central axis C from the stem 22.

The groove 50 defines a groove depth d7. The groove depth d7 extends in a direction along the central axis C. The groove depth d7 extends from the second interface 56 to the portion of the base surface 52 of the groove 50 which has the maximum depth (i.e. the portion of the base surface which is furthest along the central axis C towards the stem 22 of the die). The groove depth d7 refers to the maximum depth of the groove 50. The groove depth d7 is equal to second interface depth d5 subtracted from the cavity groove depth d3. The groove depth d7 makes up less than or equal to 75% of the cavity groove depth d3. In some embodiments, the groove depth d7 may be less than equal to 50% of the cavity groove depth d3. The size of the groove depth d7 relative to the size of the cavity groove depth d3 may be selected based on, for example, the material from which a workpiece to be joined in a rivet setting operation using the die 13 is made.

A rivet setting operation performed using the die 13 will now be described with reference to FIGS. 5 to 10. FIG. 5 shows a first stage in the rivet setting operation. A workpiece 62 is shown received between the nose assembly 16 and the die 13. The workpiece 62 comprises an upper sheet (or layer) 62a and a lower sheet (or layer) 62b. One or both of the upper sheet 62a and the lower sheet 62b may be made from aluminium. The lower sheet 62b may be formed from a material that is less ductile and/or less deformable than the upper sheet 62a. The lower sheet 62b may be made from a material that has a ductility of less than or equal to 12%, preferably 10%, elongation at break. The lower sheet 64b may be at least 2.5 mm, preferably 3 mm, thick.

The upper sheet 62a comprises an upper surface 64 and a lower surface 66. The upper surface 64 is opposed to the lower surface 66. The upper surface 64 of the upper sheet 62a is an upper surface of the workpiece 62. The lower sheet 62b comprises an upper surface 68 and a lower surface 70. The upper surface 68 is opposed to the lower surface 70. The lower surface 70 is a lower surface of the workpiece 62. In the depicted embodiment, the workpiece 62 comprises two sheets (or layers), the upper sheet 62a and the lower sheet 62b. However, in some, non-depicted, embodiments, the workpiece may comprise more than two sheets, or may comprise only a single sheet. At least one or all of the sheets may have a ductility of less than or equal to 12%. In some embodiments, at least one or all of the sheets may have a ductility of less than or equal to 8%. Material having a ductility that falls within these ranges are more prone to cracking during a rivet insertion operation. Use of the die 13 with these materials is particularly advantageous because the geometry of the die 13 reduces the likelihood of cracks forming during a rivet insertion operation. At least one of the sheets may be made from a non-heat treated cast material. At least one of the sheets may be a cast material, aluminium, possibly cast aluminium, or magnesium. The workpiece 62 may comprise at least two sheets.

In the present specification, with regard to the description of the workpiece, upper means closest, in use, to the rivet punch (and consequently furthest away from the die) and lower means furthest, in use from the rivet punch (and consequently closest to the die).

A rivet 71 is received within the nose assembly 16 of the rivet insertion apparatus 2. The rivet 71 comprises a head 72, and a shank 74 that depends from the head. The shank 74 defines a rivet cavity 76. The shank 74 defines a shank external diameter. The shank 74 defines a shank internal diameter. The rivet 71 comprises a tip 78. The tip 78 is opposed to the head 72. The tip 78 is the portion of the rivet 71 that is located furthest away from the head 72. The tip 78 defines a tip diameter. The tip 78 may define a flat land, or may define a ring cutting edge. Where the tip 78 defines a flat land, the tip diameter may be an average diameter (i.e., mid-point diameter) of the flat land. Where the tip 78 defines a ring cutting edge, the tip diameter is the diameter of the ring cutting edge. The rivet 71 preferably has a hardness of at least 380 HV10 and/or up to 580 HV10.

In the first stage of the rivet setting operation, the tip 78 of the rivet 71 engages the upper surface 64 of the upper sheet 62a of the workpiece 62. A punch 80 of the rivet insertion apparatus 2 engages the head 72 of the rivet 71, and the lower surface 70 of the workpiece 62 engages the upper surface (in particular, outer rim 40) of the die 13. The rivet 71 is then driven by the punch 80. In the present example rivet setting operation, the rivet 71 is driven by the punch 80 towards the die 13 with a velocity of up to 400 mm per second and with a maximum driving force of up to 85kN. However, in other examples, any appropriate speed and driving force may be used.

FIG. 6 shows a second stage of the rivet setting operation. In this stage, the rivet 71 has been driven into the workpiece 62 such that the tip 78 of the rivet 71 has been driven all the way through the upper sheet 62a of the workpiece 62. At this stage in the rivet setting operation, the tip 78 of the rivet 71 contacts the upper surface 68 of the lower sheet 62b of the workpiece 62. Since the rivet 71 has been driven all the way through the upper sheet 62a, a slug 82 has been cut from the upper sheet 62a and is received within the rivet cavity 76. As a result of the driving force of the punch, the workpiece 62 (and, in particular, the lower surface 70 of the workpiece, under where the rivet is located) has deflected towards the base surface 42 of the die cavity 21.

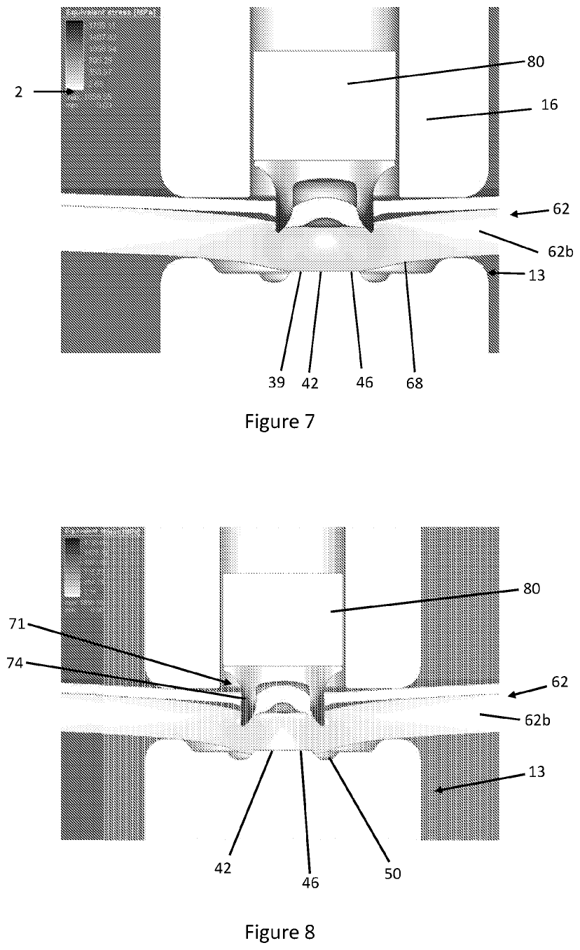

FIG. 7 shows a third stage in the rivet setting operation. In this stage, the deflection of the workpiece 62 has continued such that the workpiece 62 (and, in particular, the lower surface 70 of the workpiece, under where the rivet is located) contacts the first portion 46 of the base surface 42 of the die surface 39. After initial contact with the first portion 46, the workpiece 62 flows radially outwardly. Radially outward flow of the workpiece 62 continues until the first portion 46 is covered by the workpiece 62. The workpiece 62 remains in contact with the first portion 46 of the base surface 42 throughout the rest of the rivet setting operation. Therefore, the workpiece 62 is centrally supported with respect to the punch 80 and the die 13 throughout the majority of the rivet setting operation. Since the workpiece 62 is centrally supported throughout the majority of the rivet setting operation, the workpiece 62 is subject to compressive stress throughout this portion of the rivet setting operation. At this stage of the rivet setting operation, the workpiece 62 is supported at its lower surface by the outer rim 40 of the die 13, and by the first portion 46 of the base surface 42 of the die cavity 21.

FIG. 8 shows a fourth stage of the rivet setting operation. In this stage, continued progress of the punch 80 deforms the material of the lower sheet 62b of the workpiece 62 such that it enters the groove 50 of the base surface 42 of the die surface 39. To enter the groove 50, at least part of the workpiece 62 flows downwardly. As the punch 80 progresses, the material of the lower sheet 62b of the workpiece 62 travels along the surface of the groove 50 in a radially outward direction. Typically, at this stage of the rivet insertion operation, the shank 74 of the rivet 71 has begun to flare. That is to say, the shank 74 of the rivet 71 has begun to deform radially outwardly. Flaring of the shank 74 of the rivet 71 interlocks the rivet 71 and the material of the workpiece 62, thereby securing the rivet 71 to the workpiece 62. The stage of the rivet insertion process at which the rivet begins to flare may vary, and may occur before or after the stage depicted in FIG. 8. The stage at which flaring begins is a function of the properties of the rivet, such as the hardness of the material from which it is made, and the geometry of the rivet.

FIG. 9 shows a fifth stage of the rivet setting operation. In this stage, continued progress of the punch 80 deforms the lower sheet 62b of the workpiece 62 such that the lower sheet 62b fills the groove 50 of the base surface 42 of the die surface 39. To fill the groove 50, at least part of the workpiece 62 flows downwardly and at least part of the workpiece 62 flows upwardly. FIG. 11 shows the direction of flow of the workpiece 62 at a stage of the rivet setting operation between the fourth stage and the fifth stage. As can be seen, portion A flows downwardly and radially outwardly. At least part of portion A flows along the surface of the groove 50. Portion B flows radially outwardly. At least part of portion B flows along the surface of the groove 50. Portion C flows radially outwardly and upwardly. At least part of portion C flows along the surface of the groove 50. Portion D flows downwardly and radially outwardly. Portion E flows upwardly and radially outwardly. At least part of portion E flows along the surface of the groove 50.

Referring back to FIG. 9, during the fifth stage of the rivet setting operation, the workpiece 62 is supported at its lower surface by the first portion 46 of the base surface 42 of the die surface 39, by the groove 50, by outer rim 40 of the die surface 39, and by the second interface 56. In addition, at this stage of the rivet setting operation, the material of the workpiece 62 has filled the groove 50. The material of the workpiece 62 filling the groove 50 reduces the amount of radially outward flow of the workpiece, relative to if the groove 50 were not present. Reducing the amount of radially outward flow is desirable because this reduces the likelihood of cracks forming in the workpiece 62 during the rivet setting operation. Since the first portion depth d1 is less than the second interface depth d5, the workpiece 62 remains centrally supported in this stage of the rivet setting operation. The workpiece 62 being centrally supported subjects the workpiece 62 to compressive stress, which reduces the likelihood of cracks forming during the rivet setting operation. During this stage of the rivet setting operation, the rivet 71 has continued to flare, increasing the interlock between the rivet 71 and the workpiece 62.

FIG. 10 shows a sixth, final stage of the rivet setting operation. At this stage of the rivet setting operation, the material of the workpiece 62, in particular the material of the lower sheet 62b of the workpiece 62, has deformed in a radially outward direction. Radially outward deformation of the workpiece 62 brings the workpiece 62 into contact with the second portion 48 of the base surface 42 of the die surface 39. Therefore, at this stage of the rivet setting operation, the lower surface of the workpiece 62 is supported by the first portion 46 of the base surface 42, by the groove 50 of the base surface 42, by the second portion 48 of the base surface 42, and by the outer rim 40 of the die surface 39. Even where any cracks do form in the workpiece 62 during the previous stages of the rivet setting operation, the compression that the workpiece is subject to at the present stage at least partially closes such cracks. Closing any cracks that may form is desirable because this reduces the likelihood of contaminant ingress through the cracks of the formed joint, and hence reduces the likelihood of the created joint failing via, for example, corrosion, fatigue cracking, or moisture ingress related failures. During this stage of the rivet setting operation, the rivet 71 has continued to flare, further increasing the interlock between the rivet 71 and the workpiece 62.

Following the sixth stage of the rivet setting operation, which ends once the punch 80 is retracted, the rivet setting operation is complete. Following insertion of the rivet 71 into the workpiece 62, the rivet 71 does not pierce through the lower surface 70 of the workpiece 62. Advantageously, this reduces the likelihood of corrosion of the workpiece, which can lead to joint failure. This differs from other types of workpiece fastening operation, for example, insertion of a self-piercing rivet stud, in which the inserted fastening (e.g. stud) pierces through the entire thickness of the workpiece. In examples of such fastenings, in order for the inserted fastening to be secured to the workpiece, the inserted fastening needs to flare such that the tip of the fastening contacts the underside of the workpiece. This means that the shank of the fastening needs to be able to undergo significant deformation without breaking. For this reason, such fastenings, as compared to the self-piercing rivets used in conjunction with a rivet die in accordance with the present invention, need to be made of much softer and much more deformable material. The use of much softer and deformable materials to form self-piercing rivet studs, as compared to self-piercing rivets, means that the geometries used for dies for such fastenings differs significantly from those used for self-piercing riveting operations, as is the case for the present invention.

Although not depicted in FIGS. 5 to 10, in some embodiments, the workpiece 62 may come into contact with the sidewall 44 of the die surface 39. The workpiece 62 may deform to the point that it comes into contact with the third interface 58. Where the workpiece comes into contact with the sidewall 44, with the third interface 58, or both, any cracks that may have formed in the regions of the workpiece that contact these regions of the die 13 are at least partially closed. Whether the workpiece 62 contact the sidewall 44, the third interface 58, or both, is determined by, for example, the material from which the workpiece 62 is made, and the total thickness of the workpiece 62.

With particular reference to FIGS. 8, 9 and 10, it can be seen that the geometry of the die has been chosen such that, during a rivet setting operation, the workpiece (and, in particular, the lower surface of the workpiece) does not contact the second portion of the base surface of the die before the workpiece (and, in particular, the lower surface of the workpiece) has contacted the second interface 56.

The presently described embodiments refer to a die with a stem that depends from a lower portion of the main body of the die. It will be appreciated that, in other embodiments, the die may not include a stem. In such embodiments, where reference is made to distance measured relative to the stem, the distance will instead be measured relative to the lower portion of the main body of the die.

The presently described embodiments refer to a rivet 71 with a head 72, a shank 74 and a one side open rivet cavity 76. The geometry of the rivet die may also work for rivets with a fully tubular rivet cavity. Fully tubular rivets are preferably used with the rivet die 13 where the workpiece comprises more than two workpiece layers, and/or where the total thickness of the workpiece 62 is greater than or equal to 8 mm.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

Where a portion of a die within the present description is referred to as planar or generally planar, said portion may be said to lie on a plane, said plane being perpendicular to the central axis.

1. A rivet die for a rivet setting tool, the rivet die comprising:
a main body that defines an upper surface; and
a die cavity that is formed in the upper surface, the die cavity being defined at least in part by a base surface;
wherein the base surface comprises a groove that extends at least partly around a central axis, a first portion through which the central axis extends, and a second portion;
wherein the groove is disposed radially outwards of the first portion, and the second portion is disposed radially outwards of the groove;
wherein the groove and the second portion border one another at an interface;
and
wherein the first portion defines a first portion depth in a direction along the central axis and wherein the interface defines an interface depth in a direction along the central axis, the first portion depth being less than the interface depth.

2. The rivet die of claim 1, wherein the second portion defines a second portion depth that extends in a direction along the central axis, and wherein the entirety of the depth of the first portion is less than the entirety of the depth of the second portion.

3. The rivet die of claim 1, wherein the first portion is planar.

4. The rivet die claim 1, wherein the first portion defines a diameter with respect to the central axis and the second portion defines a radial width.

5. The rivet die of claim 4, wherein a ratio of the diameter of the first portion to the radial width of the second portion is less than four.

6. The rivet die of claim 4, wherein the diameter of the first portion is greater than or equal to the radial width of the second portion.

7. The rivet die of a claim 4, wherein the groove defines a groove radial width, and wherein the groove radial width is at least 5% of the diameter of the first portion.

8. The rivet die of claim 1, wherein the die cavity defines a die cavity depth in a direction along the central axis, and the groove defines a groove depth in a direction along the central axis, wherein optionally
the groove depth is less than or equal to 75% of the die cavity depth.

9. (canceled)

10. The rivet die of claim 1, wherein the interface depth is at least 3% greater than the first portion depth.

11. The rivet die of claim 1, wherein at least part of the first portion and at least part of the second portion are perpendicular to the central axis; and/or wherein
the rivet die further comprises a stem that extends from a lower surface of the main body, the lower surface being opposed to the upper surface; and/or wherein
the upper surface defines an outer rim disposed radially outwards of the die cavity.

12. (canceled)

13. (canceled)

14. The rivet die of claim 1, wherein the groove defines a radial midpoint that defines a radial midpoint diameter, and wherein the groove is configured such that the radial midpoint diameter is greater than or equal to a bore internal diameter of a rivet provided to the rivet setting tool prior to insertion of the rivet;
and/or where
the first portion of the base surface is continuous.

15. (canceled)

16. A rivet setting tool configured to insert a rivet into a workpiece, the rivet setting tool comprising a die according to claim 1 located beneath a punch that is reciprocally movable by an actuator.

17. A method of forming a joint comprising:
providing a rivet setting tool according to claim 16;
providing the rivet setting tool with a rivet;
providing a workpiece;
positioning the workpiece between the die and the punch; and
urging the rivet into the workpiece by advancing the punch using the actuator.

18. The method of claim 17, wherein at least one layer of the workpiece is made from a material having a ductility that is less than or equal to 12%;
and/or wherein
the rivet has a hardness of at le 380 HV10 and/or up to 580 HV10.

19. The method of claim 17, wherein the workpiece comprises:
an upper sheet that defines an upper surface of the workpiece; and
a lower sheet that defines a lower surface of the workpiece; wherein optionally
(i) after being urged into the workpiece, the rivet does not extend through the lower surface of the workpiece; and/or
(ii) the lower sheet is formed from a material that is less ductile than the upper sheet.

20-22. (canceled)

23. A product or component of a product manufactured using a method according to claim 17; optionally wherein
the product is a vehicle.

24. (canceled)

25. A method of forming a self-piercing riveted joint between separate portions of a workpiece, the method comprising:
providing i) a die that defines a central axis and a die cavity that defines a base surface, ii) said workpiece, iii) a punch, and iv) a self-piercing rivet;
positioning the workpiece between the die and the punch;
urging the rivet into the workpiece using the punch such that:
i) at least part of the workpiece flows to come into contact with the base surface of the die;
ii) at least part of the workpiece flows radially outwardly;
iii) at least part of the workpiece flows downwardly to enter a groove of a base surface of the die;
iv) at least part of the workpiece substantially fills the groove; and
v) at least part of the workpiece flows radially outwardly beyond the groove;
wherein, while the rivet is being urged into the workpiece, the rivet flares such that the rivet interlocks with at least part of the workpiece thereby creating the joint between the separate portions of the workpiece.

26. The method of claim 25, wherein to substantially fill the groove, at least part of the workpiece flows upwardly and at least part of the workpiece flows downwardly.

27. The method of claim 25, wherein (i) to (v) begin sequentially; and/or wherein
radially outward flow of the workpiece brings the workpiece into contact with a sidewall of the die.

28.(canceled)

29. The method of claim 25, wherein the groove is disposed radially outwards of a first portion of the base surface, and a second portion of the base surface is disposed radially outwards of the groove, and wherein the groove and the second portion border one another at an interface; wherein optionally
(i) the first portion defines a first portion depth in a direction along the central axis, and wherein the interface defines an interface depth in a direction along the central axis, the first portion depth being less than the interface depth: and/or
(ii) the workpiece flows radially outwardly in step (ii) along the first portion of the base surface; and/or
(iii) the workpiece flows radially outwardly in step (v) along the second portion of the base surface.

30-32. (canceled)
